(19) United States
(12) Patent Application Publication
(10) Pub. No.: US 2021/0111646 A1
(43) Pub. Date: Apr. 15, 2021

(54) MODULAR ELECTROMAGNETIC DRIVE FOR FITNESS APPLICATIONS

(71) Applicant: Arena Innovaton Corp., Laguna Beach, CA (US)

(72) Inventor: Zachary M. Rubin, Calabasas, CA (US)

(21) Appl. No.: 17/070,781

(22) Filed: Oct. 14, 2020

Related U.S. Application Data
(60) Provisional application No. 62/914,899, filed on Oct. 14, 2019.

(51) Int. Cl. H02P 3/18; A63B 24/00; A63B 21/005; H02P 23/00

(52) U.S. Cl. CPC H02P 3/18; A63B 24/0087; A63B 21/0056; H02P 23/00; A63B 21/0059

(57) ABSTRACT

A modular motor drive for use in fitness equipment includes a switching circuit having switches and that is responsive to switching control signals by selectively reconfiguring the switches to control supply of electrical energy to a motor of an exercise device according to the switching control signals. The motor drive further includes an interface coupleable with an application control board of the exercise device. Responsive to a first switching control signal, the switching circuit configures the plurality of switches to drive the motor of the exercise device. Responsive to a second switching control signal corresponding to electric braking of the motor, the switching circuit configures the plurality of switches to stop driving the motor of the exercise device.

### CROSS REFERENCE TO RELATED APPLICATIONS

The present application claims priority under 35 U.S.C. § 119 to U.S. provisional patent application 62/914,899, which was filed Oct. 14, 2019, entitled “Modular Electromagnetics Drive for Fitness Applications,” which is hereby incorporated by reference in its entirety into the present application.

### TECHNICAL FIELD

Aspects of the present invention involve motor drives for exercise and fitness applications and, in particular, modular drives for exercise equipment and control/operation thereof.

### BACKGROUND

Electromechanical exercise equipment generally includes a motor or similar force generating component that provides resistance to bio-mechanical force provided by a user. Control and monitoring of the force generating component can be dependent on the resistance to be provided, the exercise to be performed, physical characteristics of the user, potential safety concerns (both for the user and for the device itself), and many other factors.

In light of the foregoing, there is a need for a control system for use in electromechanical exercise equipment that can be readily adapted to account for the wide range of potential variability in such equipment. It is with these issues in mind that aspects of the present disclosure were conceived.

### SUMMARY

In one aspect of the present disclosure a modular motor drive for use in fitness equipment is provided. The modular motor drive includes a switching circuit including a plurality of switches. The switching circuit is responsive to switching control signals by selectively reconfiguring the plurality of switches to control supply of electrical energy to a motor of an exercise device according to the switching control signals. The motor drive further includes an interface coupleable with an application control board of the exercise device. Responsive to a first switching control signal, the switching circuit configures the plurality of switches to drive the motor of the exercise device. Responsive to a second switching control signal corresponding to electric braking of the motor, the switching circuit configures the plurality of switches to stop driving the motor of the exercise device.

In certain implementations, the motor is an alternating current (AC) motor and at least one of the switching circuit or a braking control circuit of the modular motor drive is configured to apply direct current (DC) to a stator winding of the motor responsive to the second switching control signal, thereby braking the motor by DC injection braking.

In other implementations, at least one of the switching circuit or a braking control circuit is configured to reverse a field of a stator winding of the motor responsive to the second switching control signal, thereby braking the motor by plug braking. In such implementations, the motor may be an AC motor and reversing the field of the stator winding may include reversing a rotation of the field of the stator winding.

In still other implementations, at least one of the switching circuit or a braking circuit is configured to route power generated by the motor responsive to the second switching control signal, thereby braking the motor by regenerative braking. In such implementations, the modular motor drive may further include a second interface for operably interconnecting the at least one of the switching circuit and the braking circuit to a power system of the exercise device to provide power from the motor to the power system during regenerative braking.

In other implementations, the modular motor drive includes a motor drive controller communicatively coupled to the switching circuit and the interface is further for communicatively coupling the motor drive controller to an application controller of the application control board. In such implementations, the switching circuit may be configured to receive the switching control signals from the motor drive controller.

In certain implementations, the interface is further for communicatively coupling the switching circuit to an application controller of the application control board. In such implementations, the switching circuit may be configured to receive the switching control signals from the application controller.

In another implementation, the second switching control signal is generated responsive to a user event associated with a user of the exercise device. The user event may be detectable based on at least one of meeting a threshold deviation from a force profile, detecting a loss of signal from a sensor, detecting a force reading indicative of a user imbalance, detecting a sensor signal indicative of user disengagement, or receiving a signal from an algorithm identifying possible user safety issues by monitoring at least one of system, environmental, or state information.

In yet another implementation, at least one of the switching circuit and a braking circuit is configured short phases of the motor responsive to receiving the second switching control signal. In such implementations, the at least one of the switching circuit and the braking circuit may be configured to default into a state in which the motor phases are shorted.

In another aspect of the present disclosure, an exercise device is provided. The exercise device includes a motor assembly including a motor; an application board including an application board controller, and a motor drive operably coupled to each of the motor and the application board. The motor drive includes a switching circuit including switches and is responsive to switching control signals by selectively reconfiguring the switches to control supply of electrical energy to the motor according to the switching control signals. Responsive to a first switching control signal, the switching circuit configures the plurality of switches to drive the motor. Responsive to a second switching control signal corresponding to electric braking of the motor, the switching circuit configures the plurality of switches to stop driving the motor.

In certain implementations, the switching circuit is configured to receive the first control signal and the second control signal from the application board controller. In other implementations, the motor drive further includes a motor drive controller operably coupled to the application board controller and the switching circuit is configured to receive the first control signal and the second control signal from the motor drive controller.

In still other implementations, the electric brake is one of a DC injection brake, a plug brake, or a regenerative brake.

In yet another aspect of the present disclosure, a method of controlling motors in fitness equipment is provided. The method includes, at a switching circuit of a motor drive coupled to a motor of an exercise device, receiving a switching control signal. The switching circuit includes a switches and is responsive to switching control signals by selectively reconfiguring the switches to control supply of electrical energy to the motor according to the switching control signals. The method further includes, responsive to receiving the control signal during driving of the motor, activating the switching circuit to stop driving the motor and applying an electric brake to the motor by at least one of DC injection braking, plug braking, or regenerative braking. The exercise device includes each of an application board including an application controller and a modular motor drive operably connected to the application board. The modular motor drive includes the switching circuit and a motor drive controller operably connected to the application controller and the switching control signal is received by the switch circuit from the motor drive controller.

In certain implementations, the modular motor drive is a first modular motor drive, the switching circuit is a first switching circuit. In such implementations, the method may further include, subsequent to replacement of the first modular motor drive with a second modular motor drive and at a switching circuit of the second modular motor drive, receiving a second control signal and, responsive to receiving the second control signal, activating the switching circuit to at least one of drive the motor or electrically brake the motor.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 is a block diagram of an exercise device according to the present disclosure.

FIG. 2 is a block diagram of a first system architecture that may be implemented in exercise devices according to the present disclosure.

FIG. 3 is a block diagram of a second system architecture that may be implemented in exercise devices according to the present disclosure.

FIG. 4 is a block diagram of a third system architecture that may be implemented in exercise devices according to the present disclosure.

FIG. 5 is a block diagram of a fourth system architecture that may be implemented in exercise devices according to the present disclosure.

FIG. 6 is a block diagram of a fifth system architecture that may be implemented in exercise devices according to the present disclosure.

FIG. 7 is a block diagram of a sixth system architecture that may be implemented in exercise devices according to the present disclosure.

FIG. 8 is a block diagram of a seventh system architecture that may be implemented in exercise devices according to the present disclosure.

FIG. 9 is a block diagram of a power multiplexer for use in exercise devices according to the present disclosure.

FIG. 10 is a flow chart illustrating a method of braking that may be implemented in exercise devices according to the present disclosure.

FIG. 11 is a block diagram illustrating an example computing system may implement various systems, processes, and methods provided herein.

### DETAILED DESCRIPTION

The present disclosure is directed to an electronic motor drive (also referred to herein as a motor drive or driver) to control electromagnetic actuators (e.g. motors). In particular, motor drives disclosed herein have specific design attributes that make them particularly well-suited for use in fitness equipment for which the electromagnetic actuator provides counterforce against bio-mechanical force generated by a user's movement during aerobic and/or anaerobic exercise. While not limited to such applications, embodiments described herein will reference such fitness applications.

Certain aspects of the present disclosure are directed to modular motor drives and, more specifically, modular motor drives that may be coupled with application-specific electronics for purposes of providing exercise devices having different performance characteristics. In at least one implementation, such modular motor drives may be substantially standalone units including switching circuitry and an interface for coupling to an application control board specific to a particular type or version of an exercise device. During operation, the switching circuity of the modular motor drive is used to drive a motor in accordance with switching signals received from a controller of the exercise device. Such switching signals may be provided by a controller of the application control board or by a controller integrated into the modular motor drive. Accordingly, the terms control signals in the context of such signals received by the switching circuit should generally be understood to include signals to control switching of the switching circuit. As discussed below in further detail, functionality of an exercise device according to the present disclosure may be distributed in various ways between the modular motor drive and the application control board.

Modular motor drives according to the present disclosure may provide various benefits related to manufacturing and product customization. For example, modular motor drives may be designed for use in multiple types of exercise devices, thereby enabling volume-cost leveraging of the modular motor drive. As another example, device resistance range, functionality, and the like may be expandable or customizable by enabling users to swap modular motor drives of a given exercise device. Accordingly, modular motor drives in accordance with the present generally result in electromechanical fitness equipment that can be developed and manufactured more cost effectively, is more reliable, is more versatile, is more manufacture-friendly, and is extensible/upgradable, relative to equipment with unique purposed-built customized motor drives, among other benefits.

Although not limited to such exercise devices, examples of cable-based exercise devices within which motor drives and other aspects of the present disclosure may be implemented are discussed in U.S. patent application Ser. No. 16/410,971 (“Strength Training and Exercise Platform”) filed on May 13, 2019, which is hereby incorporated by reference in its entirety and for all purposes.

### A. General Architecture

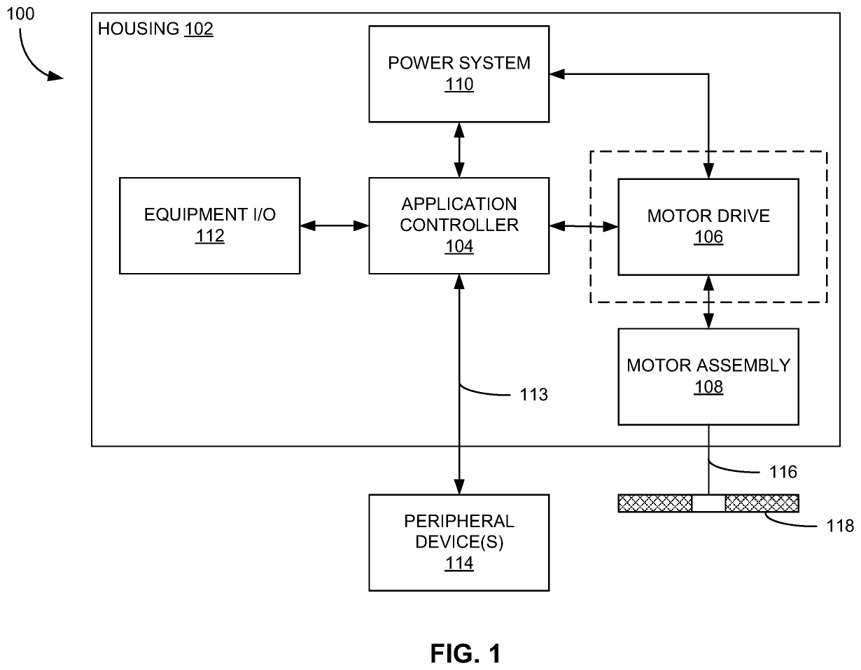

FIG. 1 is a block diagram of an exercise device 100 according to an implementation of the present disclosure. Exercise device 100 generally includes a housing 102 within which various electronic components may be disposed. For example, and without limitation, such components include an application controller 104, a motor drive 106, a motor assembly 108, a power system 110, and equipment input/output (I/O) 112. In certain implementations, application controller 104 and/or motor drive 106 may be configured to communicate with one or more peripheral devices 114 external housing 102 through a wired and/or wireless connection 113. As described below in further detail, motor assembly 108 extends or retracts a link 116, which may be coupled to an exercise accessory 118.

Link 116 may be any suitable component that the motor assembly 108 may selectively extend from and/or retract into housing 102. Exercise accessory 118 may be an optional accessory that may be coupled to or that is disposed on an end of link 116 to facilitate performance of various exercises. Exercise device 100 may be configured to allow exercise accessory 118 to be swapped, removed, or otherwise modified such that different exercises may be performed using exercise device 100. In at least certain implementations and without limitation, link 116 and exercise accessory 118 may be a cable and a handle, respectively. Accordingly, for purposes of clarity, link 116 and exercise accessory 118 are referred to hereinafter as cable 116 and handle 118.

Exercise device 100 includes each of an application controller 104 and a motor drive 106. In at least certain implementations, application controller 104 controls and supervises exercise device-specific functionality. Among other things, such functionality may include communication with peripheral devices 114, control and monitoring of equipment I/O 112, power management (e.g., by monitoring and control of power system 110), and interfacing with motor drive 106. Motor drive 106, on the other hand, includes suitable components (e.g., switching components) to control current to motor assembly 108, which generally includes a motor but may further include sensors, actuators, and other motor-related I/O components.

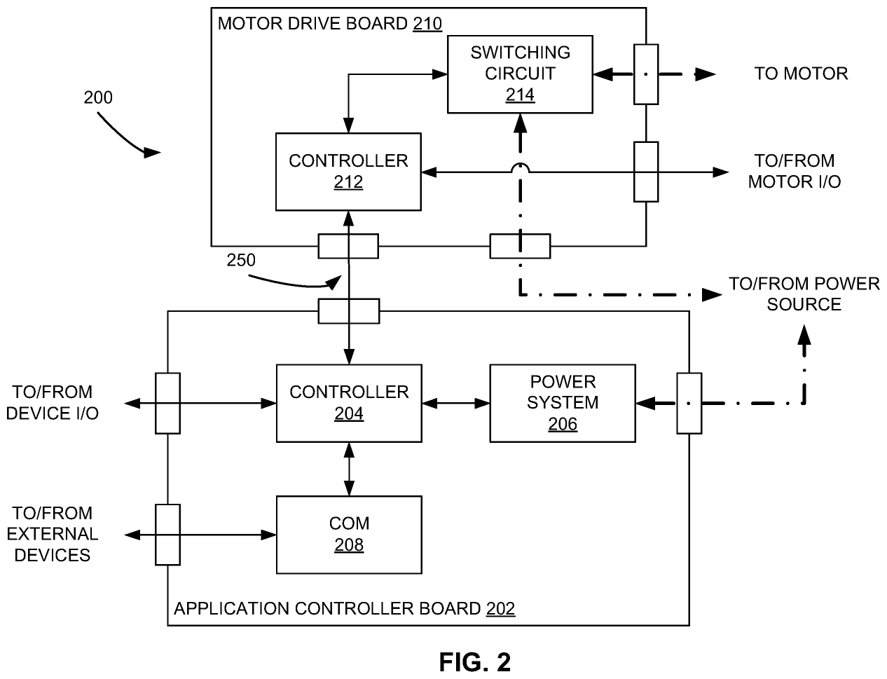

The foregoing description of application controller 104, motor drive 106, and their respective functions is merely one example and functionality may be distributed differently between application controller 104 and motor drive 106. More generally, motor drive 106 provides and controls power to a motor of motor assembly 108 according to an operational state of exercise device 100. For example, motor drive 106 may control the voltage, current, frequency, mode current (e.g., AC versus DC), commutation mode (e.g., sinusoidal, square, saw, etc.), polarity, or other similar parameters of power being provided to the motor of motor assembly 108. Application controller 104, on the other hand, at least provides an interface for motor drive 106 with other components of exercise device 100. Supervision and control of the various functions of exercise device 100 may be divided between application controller 104 and motor drive 106 in a variety of different ways. For example, in one implementation, motor drive 106 may consist of only a switching circuit and suitable interfaces to application controller 104 and motor assembly 108. In such cases, control of the switching circuit (e.g., through switching signals) and substantially all other functions of exercise device 100 may be handled by application controller 104. Conversely, in another implementation, application controller 104 may provide only an interface between motor drive 106 and other components of exercise device 100 with the remaining functionality of exercise device 100 being handled by a controller integrated into motor drive 106. Other implementations of the present disclosure involve alternative distributions of functionality between application controller 104 and motor drive 106 and, as a result, lie somewhere between the foregoing implementations. Non-limiting examples of embodiments of the present disclosure in which exercise device functionality is differently divided between application controller 104 and motor drive 106 are discussed below in the context of FIGS. 2-8.

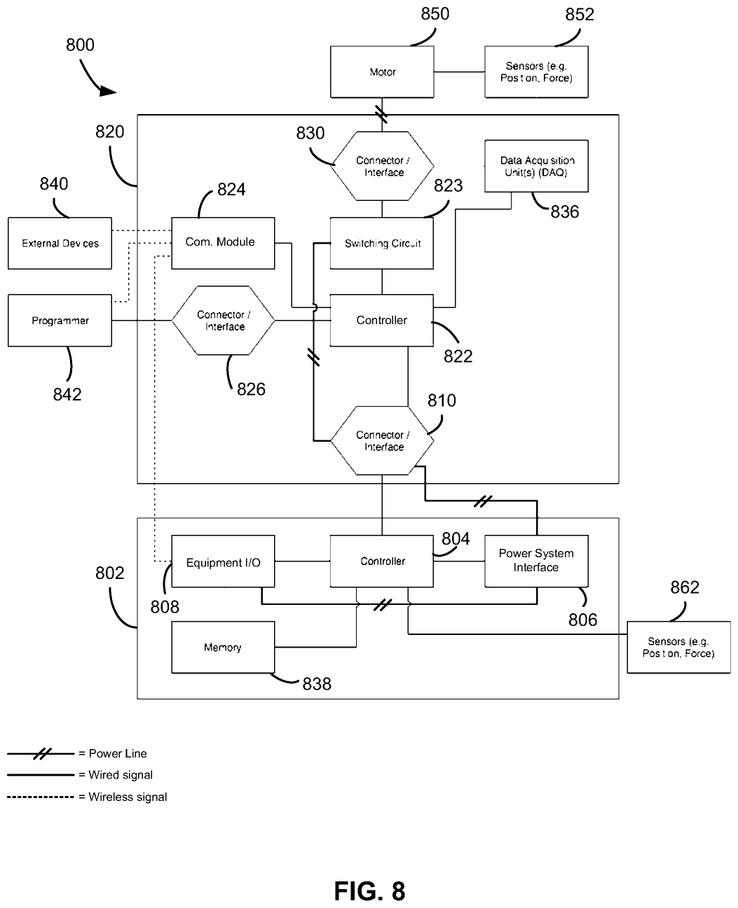

Exercise device 100 may include a power system 110, which may be controlled, at least in part, by one or both of application controller 104 and motor drive 106. Power system 110 generally includes components directed to control, distribution, storage, recovery, and the like of power during operation of exercise device 100. As described below in the context of FIG. 8, power systems for use in exercise devices according to the present disclosure may include power multiplexers that dynamically, efficiently, and intelligently route power between different systems and components of the exercise device.

As noted above, exercise device 100 may include equipment I/O 112. In general, equipment I/O 112 includes any components of exercise device 100 for receiving input from a user or other device or for providing output to a user or other device. In certain implementations, equipment I/O 112 includes various sensors for measuring operational parameters of exercise device 100. For example, and without limitation, such sensors may include load sensors (e.g., strain gauges or load cells), electrical sensors (e.g., current sensors, voltage sensors, potentiometers/rheostats), motion-related sensors (e.g., accelerometers, encoders), buttons/switches, temperature sensors, light sensors, and the like. Equipment I/O 112 may also include input devices for receiving input from a user including, without limitation, buttons/keys, switches, touchscreens, mice/trackballs, microphones, and the like. Equipment I/O 112 may also include output devices such as, but not limited to, screens/displays, lights, speakers, haptic feedback devices, and the like. It should be understood that the foregoing examples of equipment I/O 112 are non-limiting and equipment I/O 112 more generally includes any suitable I/O devices that may be included in exercise device 100 for purposes of facilitating operation of exercise device 100, for receiving input from a user or other device, for providing output to a user or other device, and the like. Moreover, while illustrated as a separate bock in FIG. 1, equipment I/O 112 may also be integrated, at least in part, within other components of exercise device 100. For example, each of power system 110, motor drive 106, and motor assembly 108 may include sensors, actuators, switches, and other similar I/O devices, each of which may be communicatively coupled to application controller 104 or another controller (e.g., a controller of motor drive 106) included in exercise device 100.

Exercise device 100 may also be configured to communicate (wired or wirelessly) with one or more peripheral devices 114. For example, and without limitation, peripheral devices 114 may include desktop computers, laptop computers, tablets, smartphones, remote server systems, or any other similar computing device.

While generally discussed herein as including a single motor assembly (e.g., a single motor with associated sensors and actuators), implementations of the present disclosure are not limited to including a single motor assembly. Rather, implementations of the present disclosure may include multiple motor assemblies, each configured to actuate a corresponding link. In implementations including multiple motor assemblies, the exercise device may include a respective motor drive for each motor assembly or a single motor drive may be configured to operate multiple motor assemblies. Accordingly, implementations discussed herein including a single motor/motor assembly may be modified to include additional motors or motor assemblies, e.g., by including additional motor drives or configuring switching circuits, controllers, etc. to control multiple motors.

### B. Modularity

In at least certain implementations of the present disclosure, motor drive 106 is configured to be modular. Stated differently, motor drive 106 may be a substantially unitary component that can be readily coupled to application controller 104. In at least certain implementations, application controller 104 and motor drive 106 are configured such that motor drive 106 may be readily coupled (electrically and/or mechanically) to application controller 104 such that motor drive 106 may be easily swapped with alternative motor drives. Examples of such couplings may include, but are not limited to plug-in stacking connectors, through-hole pins, solder pads, and dual in-line memory module (DIMM)-/small outline DIMM (SO-DIMM)-style PCB connectors. In certain implementations, motor drive 106 may be designed and fabricated as an integrated circuit component. In other implementations, motor drive 106 may be a module that may be coupled to application controller 104, e.g., via a cable or flex ribbon. To facilitate swapping of motor drive 106, housing 102 may include a hatch, door, slot, or similar opening through which motor drive 106 may be inserted or from which motor drive 106 may be removed without further disassembly of exercise device 100.

Modular motor drives may vary in power levels, input voltages, speed ranges, heat dissipation capability, number of motor drive channels, output waveforms, or other similar features. In at least certain applications, a single motor drive may be used across a range of exercise devices. Accordingly, a common motor drive may be used in exercise devices having different form factors (e.g., rower/ergometer, cable machine, rope puller, treadmill, cable-based exercise platform, etc.) or different possible configurations, thereby simplifying manufacturing through standardization and facilitating volume-cost leveraging of the motor drive. A single exercise device may also be compatible with multiple modular motor drives, which may be used to vary features of the exercise device. So, for example, a manufacturer may produce a base unit of an exercise device within which different modular motor drives may be inserted to create multiple versions of exercise devices, each version having different features or capabilities. Similarly, following an initial purchase of an exercise device having a first motor drive, a user could purchase and swap in a second motor drive that expands functionality of the exercise device, e.g., by increasing the maximum available resistance, adding different exercise modalities, and the like.

To further increase volume-cost leveraging, other components that may be universal or near universal to multiple types of exercise equipment may be integrated into the modular motor drive. For example, and without limitation, wired communication systems (e.g., USB, firewire, Ethernet, etc.), wireless communication systems (e.g., WiFi, Bluetooth, ANT/ANT+, cellular, etc.), speakers, UI controls, lights, LEDs, touchscreens, thermal regulation elements, and the like may be integrated with the motor drive.

In at least certain implementations, a modular motor drive may also reduce the propensity of electrical noise associated with control of the motor to propagate through other systems/components of the exercise device (e.g., application controller 104 or communications-related components) and impact their operation. Nevertheless, application controller 104, motor drive 106, or any other system or component of exercise device 106 may include shielding where appropriate, to further mitigate effects of electrical noise whether produced by a motor of exercise device 100 or other sources.

Additional benefits that may be associated with implementation of modular motor drives include improved mechanical footprint, mechanical stability (e.g., vibrational or otherwise), and simplification of thermal management of electronics. Thermal management may be active or passive including, but not limited to, air cooling, use of phase change materials (PCMs), liquid cooling (e.g., static or flowing), or implementations of one or more heat sinks.

It should be understood that referring to motor drive 106 as being modular should not imply any particular limitations regarding the size or configuration of motor drive 106 and application controller 104 other than that each of motor drive 106 and application controller 104 are substantially unitary. For example, as discussed herein, motor drive 106 is generally referred to as being swappable with a base unit including application controller 104. However, in other implementations, motor drive 106 may be incorporated into a base unit that further includes motor assembly 108 and other components of exercise device 100, the base unit being configured to receive multiple different application controllers 104. In such implementations, each of motor drive 106 and application controller 104 would nevertheless be considered modular as they are substantially unitary components that may be communicatively coupled to each other. Similarly, in certain implementations, either of motor drive 106 and application controller 104 may be considered a motherboard to which the other of motor drive 106 and application controller 104 may be coupled as a daughterboard.

### C. Other Example Architectures

As discussed above, exercises devices in accordance with the present disclosure may include an application controller and a modular motor drive between which various functions of the exercise device may be distributed. While not limiting, FIGS. 2-8 are block diagrams of example system architectures intended to illustrate at least some possible configurations of exercise devices in accordance with the present disclosure.

FIG. 2 is a block diagram of a first system architecture 200 for an exercise device in accordance with the present disclosure. As illustrated, an application controller board 202 is communicatively coupled to a motor drive board 210 via an interface 250. Application controller board 202 includes a controller 204 that controls various functions of the exercise device including, but not limited to, control and monitoring of a power system 206, managing communication via a communication (COM) unit 208, and managing device I/O.

Motor drive board 210 includes a controller 212 communicatively coupled to a switching circuit 214. Switching circuit 214 is in turn connected to the motor of the exercise device. Controller 212 is further communicatively coupled to I/O (e.g., sensors, actuators) of the motor to facilitate monitoring, data collection, control, and other functions associated with operation of the motor.

Each of switching circuit 214 and power system 206 are shown as being connected to a power source (e.g., as indicated by a dash-dot line), such as an electrical outlet.

Although switching circuits of motor drives according to the present disclosure are not necessarily limited to such variations, at least certain switching circuits include a 4-switch configuration (e.g., an H-bridge, used for direct current (DC) motors) or 6-switch configuration (e.g., a “six-pack”, used for alternating current (AC) and brushless DC (BLDC) motors). The switches in such configurations generally include transistors (e.g., MOSFET or IGBT), or other electrical switching components. During operation, the switches of the switching circuit are controller (e.g., by switching signals received from controller 204 or controller 212) to regulate the amount, direction, frequency, etc., of current flowing to the motor and its phases.

The configuration of FIG. 2 is intended to illustrate a first example architecture in which motor-related functionality is substantially isolated/separated from other functions of the exercise device. Although described as including operatively coupled “boards”, the term “board” is used primarily for simplicity and clarity. No specific meaning should be attributed to use of the term board beyond the motor drive board 210 and application controller board 202 being physically separate and substantially unitary components operatively coupled through interface 250. To the extent the term “board” is used herein in the context of the application controller and motor drive, such language is intended only to facilitate differentiation between separate system components and should not be considered to add any specific structural limitations regarding the motor drive or application controller.

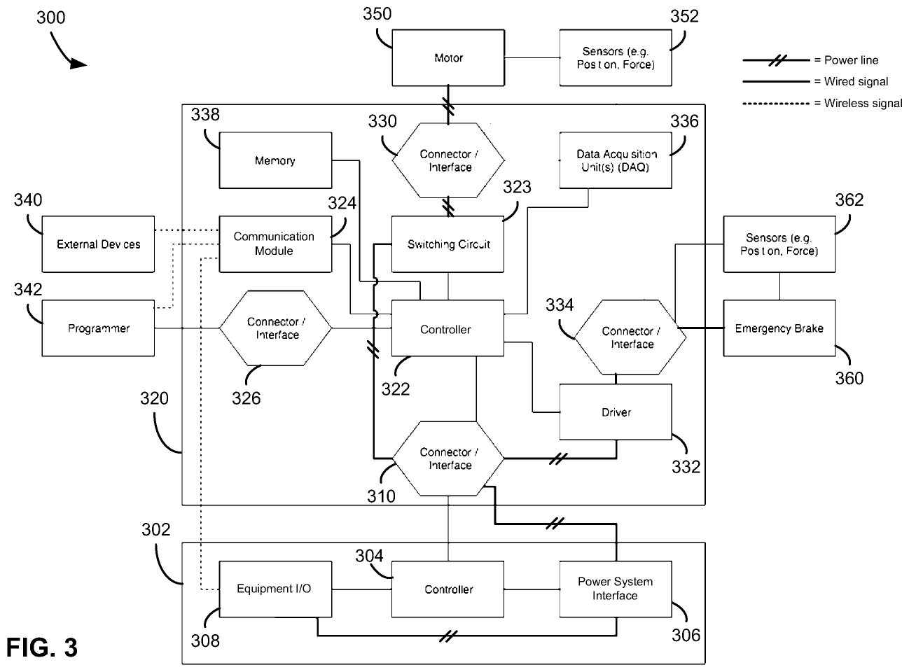

FIG. 3 is a block diagram of a second system architecture 300 for an exercise device in accordance with the present disclosure. System architecture 300 includes an application controller board 302 communicatively coupled to a motor drive board 320 via a first interface 310, referred to hereinafter as drive/application board interface 310. Application controller board 302 includes a controller 304 that controls various functions of the exercise device including, but not limited to, control and monitoring of a power system via a power system interface 306 and managing equipment I/O 308.

Motor drive board 320 includes a controller 322. In the implementation of FIG. 3, controller 322 manages functionality including communication with external devices, control and monitoring of the exercise device motor, control and monitoring of an emergency brake system, and data collection.

With respect to communication with external devices, controller 322 may generally control and manage communication with external devices such as, but not limited to, other computing devices (e.g., desktop computers, laptop computers, smartphones, tablets, etc.). To facilitate such communication, motor drive board 320 may include a communication module 324 that enables wired and/or wireless communication with external devices 340. As illustrated in FIG. 3, communication module 324 may further facilitate communication with a programmer device 342 (e.g., a specialized computing device for programming or reconfiguring the exercise device) as well as equipment I/O 308 of the exercise device. Motor drive board 320 may also include an external device interface 326 to facilitate communication with external devices, such as the programmer 342, as illustrated in FIG. 3.

With respect to control and monitoring of the exercise device motor, controller 322 may be communicatively coupled to and may control a switching circuit 323. Switching circuit 323 may in turn be coupled to a motor 350 via a motor interface 330 and may control delivery of current to motor 350 responsive to switching signals received from controller 322.

With respect to control and monitoring of an emergency brake system, controller 322 may be communicatively coupled to a driver 332 adapted to deliver power to an emergency braking system including an emergency brake 360. In certain implementations, the emergency braking system may be a mechanical brake configured to rapidly stop and lock motor 350. In other implementations, emergency braking system may further or alternatively include an electronic braking system, such as a DC injection braking system or plug braking system. Accordingly, in implementations including an emergency braking system, motor drive board 320 may include an emergency brake interface 334 through which power may be delivered from the driver 332 to the emergency brake 360, either to engage a mechanical brake or to provide power to facilitate electronic braking.

With respect to data collection, motor drive board 320 may include one or more data acquisition units 336 communicatively coupled to controller 322 and configured to obtain, receive, process, store, etc. data from various sensors of systems of the exercise device system. For example, as illustrated, data acquisition unit 336 is communicatively coupled to each of motor sensors 352 and emergency brake sensors 362, e.g., through motor interface 330 and emergency brake interface 334, respectively. Motor sensors 352 may measure various parameters including, but not limited to, position, force, speed, acceleration, electrical parameters (e.g., current, voltage, etc.), and other similar operational parameters of motor 350. Similarly, emergency brake sensors 362 may measure, without limitation, position, force, speed, acceleration, electrical parameters (e.g., current, voltage, etc.) and other similar operational parameters of emergency brake 360.

As further illustrated in FIG. 3, controller 322 may also be communicatively coupled to memory 338, which may be used to store instructions and data for use and execution by controller 322. Memory 338 may also store data and instructions for use and execution by controller 304 of application control board 302.

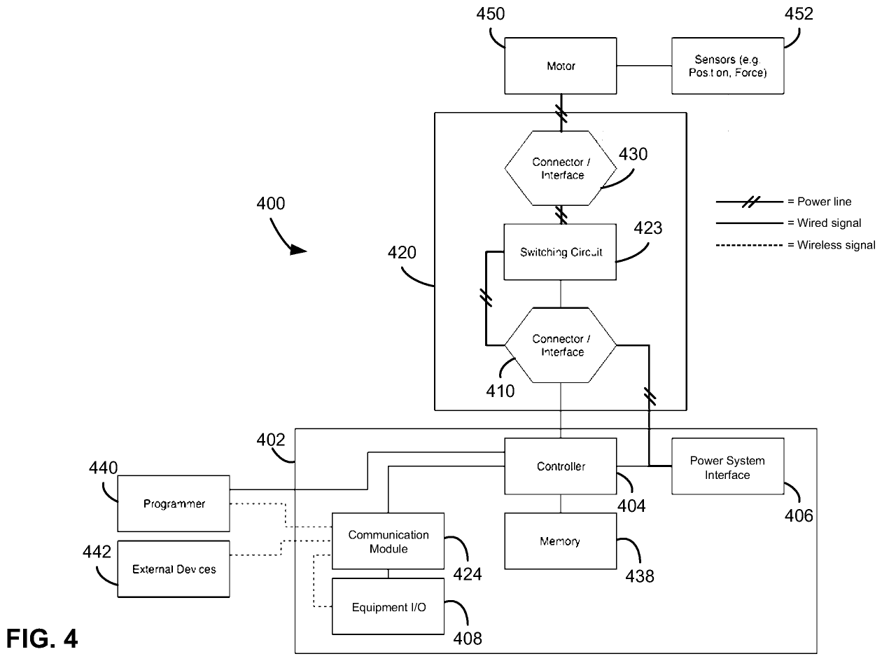

FIG. 4 is a block diagram of a third system architecture 400 for an exercise device in accordance with the present disclosure. System architecture 400 includes an application controller board 402 communicatively coupled to a motor drive board 420 via a first interface 410, referred to hereinafter as drive/application board interface 410. In contrast to the implementation of FIG. 3, in which motor drive board 320 provided a substantial amount of functionality related to operation of the exercise device, system architecture 400 illustrates an alternative in which substantial functions of the exercise device are controller/managed by application controller board 402 with the exception of switching functionality, which is provided by a switching circuit 423 of motor drive board 420.

As illustrated in FIG. 4, application controller board 402 includes a controller 404 that controls various functions of the exercise device including, but not limited to, control and monitoring of a power system through a power system interface 406 and general communications with both components of the exercise device and external devices. To do so, application controller board 402 may include a communication module 424 that facilitates wired and/or wireless communication with other devices and components including, but not limited to a programmer 440, external devices 442, and equipment I/O 408. Application controller board 402 may also include a memory 438 for storing data and instructions executable by controller 404.

As previously noted, motor drive board 420 is relatively minimal as compared to motor drive board 320 of FIG. 3. More specifically, motor drive board 420 includes a switching circuit 423 that is coupled to application board 402 via drive/application board interface 410. As illustrated in FIG. 4, motor drive board 420 may not include its own, separate controller. In such implementations, switching circuit 423 may instead be controlled by controller 404 of application board 402, e.g., by receiving switching signals from controller 404 through drive/application board interface 410. Similarly, drive/application board interface 410 may also facilitate power transmission to switching circuit 423, e.g., from the power system through the power system interface 406. Motor drive board 420 may also include a motor interface 430 for facilitating power transmission and communication with a motor 450 of the exercise device and associated motor sensors 452.

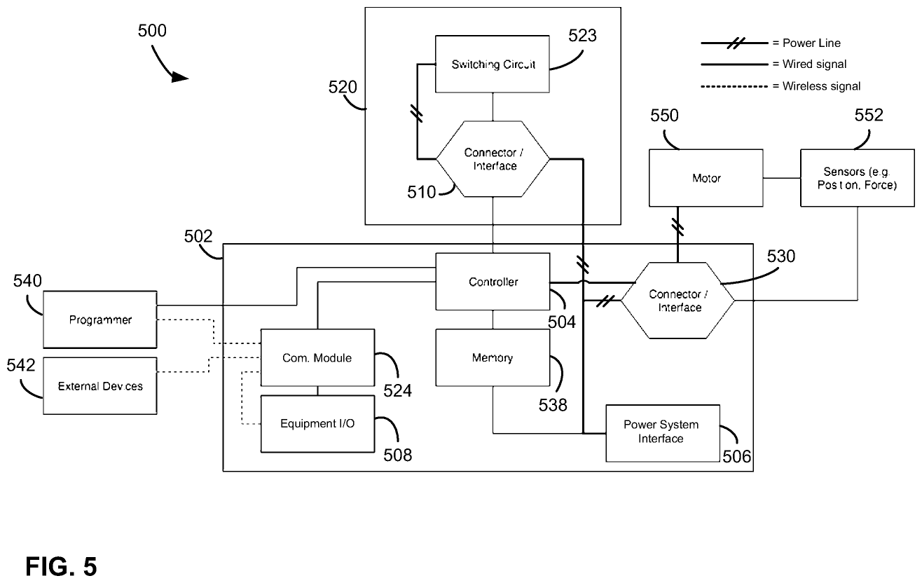

FIG. 5 is a block diagram illustrating a fourth system architecture 500 for an exercise device in accordance with the present disclosure. System architecture 500 includes an application controller board 502 communicatively coupled to a motor drive board 520 via a drive/application board interface 510. Similar to the implementation of FIG. 4, substantial functionality of the exercise device is controller/managed by application controller board 502 while primarily motor switching functionality is provided by motor drive board 520.

Application controller board 502 includes a controller 504 that may be communicatively coupled to a memory 538 and that controls various functions of the exercise device including, but not limited to, control and monitoring of a power system through a power system interface 506 and general communications with both components of the exercise device and external devices. For such communications, application controller board 502 may further include a communication module 524 that facilitates wired and/or wireless communication with other devices and components such as, but not limited to a programmer 540, external devices 542, and equipment I/O 508.

Similar to motor drive board 420 of FIG. 4, motor drive board 520 is generally limited to switching functionality and, as a result, includes a switching circuit 523 that receives switching signals from and is generally controlled by controller 504 of application board 502, e.g., through drive/application board interface 510. However, unlike motor drive board 420, which included a motor interface 430, motor drive board 520 does not connect directly to a motor 550 or motor sensors 552 of the exercise device. Rather, power controlled by switching circuit 523 is passed back through application controller board 502 and through a motor interface 530 of application controller board 502 to motor 550.

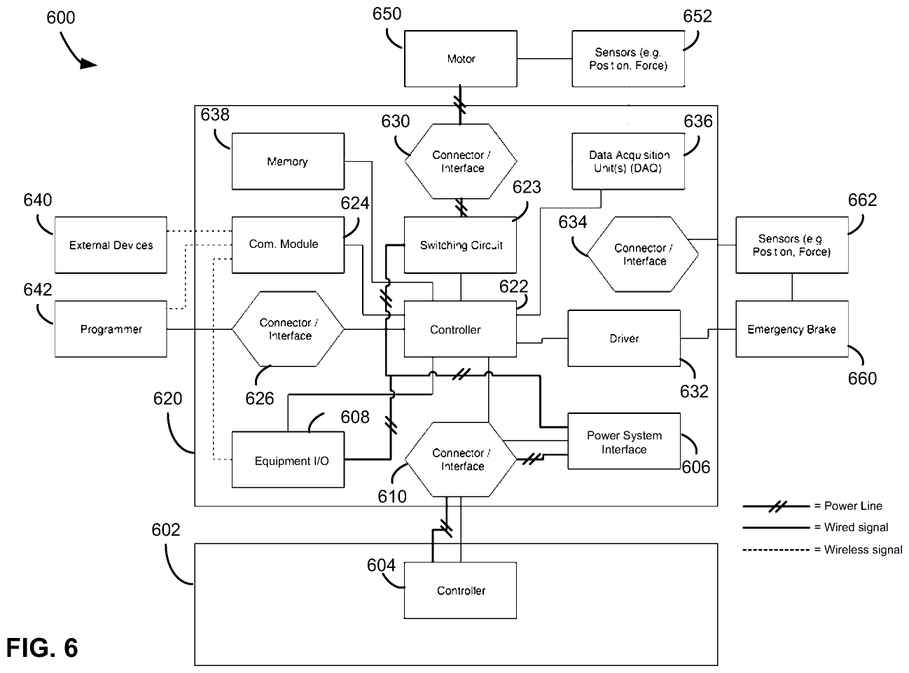

FIG. 6 is a block diagram of a fifth system architecture 600 for an exercise device in accordance with the present disclosure. System architecture 600 includes an application controller board 602 communicatively coupled to a motor drive board 620 via a drive/application board interface 610. In contrast to the implementations of FIGS. 4 and 5, which included motor drive boards having relatively limited functionality, FIG. 6 illustrates an implementation in which the motor drive board 620 handles significantly more operations of the exercise device.

In the implementation of FIG. 6, application controller board 602 generally includes a controller 604 that may perform at least some basic functionality associated with the exercise device. For example, application controller board 602 may handle non-motion related control tasks such as, but not limited to, wired or wireless networking, loading and storing user data, or determining a current state (e.g., on/off) of the exercise device.

A substantial portion of the remaining functionality of the exercise device is handled by motor drive board 620, which includes a controller 622. Similar to architecture 300 of FIG. 3, various functions related to operation of the exercise device are handled by controller 622 and corresponding components of motor drive board 620. For example, controller 622 controls switching circuit 623, which in turn provides power to motor 650 via a motor interface 630 in accordance with switching signals and settings received from controller 622. A communications module 624 and an external device interface 626 also facilitate wired and wireless communication, e.g., with a programmer 642 and/or external devices 640. Controller 622 also handles monitoring and control of an emergency brake system which may include a driver 632 for providing power to an emergency brake 660. Motor drive board 620 may also facilitate data collection and processing. For example, motor drive board 620 may include one or more data acquisition units 636 for collecting data from, without limitation and among other things, motor sensors 652 (e.g., through motor interface 630), and emergency brake sensors 662 (e.g., through an emergency brake interface 634). Controller 622 may also be communicatively coupled to a memory 638 for use in storing data and instructions, including data and instructions for use by controller 622 or control 604.

In contrast to architecture 300 of FIG. 3, which included equipment I/O 308 and power system interface 306 as part of application board 302, architecture 600 moves each of equipment I/O 608 and a power system interface 606 to motor drive board 620.

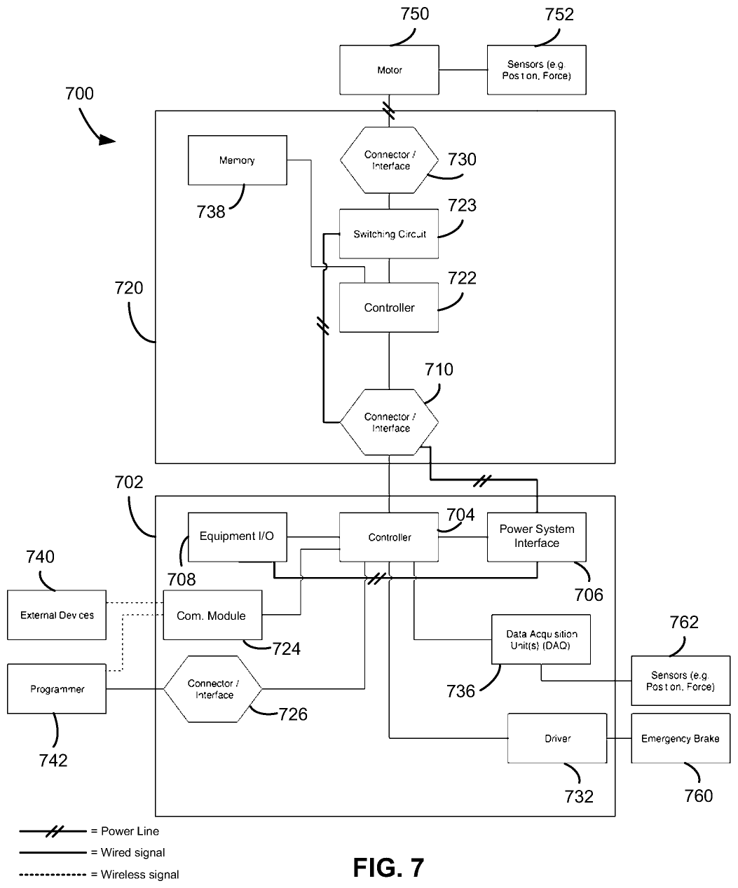

FIG. 7 is a block diagram of a sixth system architecture 700 for an exercise device in accordance with the present disclosure. System architecture 700 includes an application controller board 702 communicatively coupled to a motor drive board 720 via a drive/application board interface 710. Like system architecture 300 of FIG. 3, system architecture 700 involves a distribution of exercise device control and operation between the application controller board 702 and motor drive board 720, albeit with more functionality handled by application board 702 than application board 302 of FIG. 7.

Application controller board 702 includes a controller 704 that controls various functions of the exercise device including, but not limited to, control and monitoring of a power system via a power system interface 706 and managing equipment I/O 708. Application controller board 702 further includes a communication module 724 and external device interface 726 that facilitates wired and/or wireless communication with other devices and components including, but not limited to a programmer 740 and external devices 742. Application controller board 702 further controls an emergency brake 760 via a driver 732 and before various data acquisition functions using one or more data acquisition units 736. For example, data acquisition unit 736 may be in communication with one or more emergency brake system sensors 762.

As noted above, motor drive board 720 is coupled to application controller board 702 via a driver/application board interface 710. Motor drive board 720 includes a separate controller 722 communicatively coupled to controller 704 of application board 702. Controller 722 controls operation of switching circuit 723, which in turn provides power to a motor 750 of the exercise device through a motor interface 730. Controller 722 may also be communicatively coupled to a memory 738 for use in storing data and instructions, including data and instructions for use by controller 722 or control 704.

Motor 750 may include motor sensors 752, signals from which may be received through motor interface 730 and passed through to data acquisition unit 736 for processing. Similarly, data acquisition unit 736 may receive additional signals from emergency brake sensors 762.

FIG. 8 is a block diagram of a seventh system architecture 800 for an exercise device in accordance with the present disclosure. System architecture 800 includes an application controller board 802 communicatively coupled to a motor drive board 820 via a drive/application board interface 810. Like system architecture 700 of FIG. 7, system architecture 800 includes a distribution of exercise device control and operation between application controller board 802 and motor drive board 820.

Application controller board 802 includes a controller 804 that controls various functions of the exercise device including, but not limited to, control and monitoring of a power system via a power system interface 806 and managing equipment I/O 808. Application controller board 802 further includes a memory 838 for storing data and/or instructions for use in operating the exercise device.

Motor drive board 820 includes a controller 822 communicatively coupled to controller 804 of application controller board 802. Motor drive board 820 includes a separate controller 822 communicatively coupled to controller 804 of application board 802. Controller 822 controls operation of switching circuit 823, which in turn provides power to a motor 850 of the exercise device through a motor interface 830. Motor drive board 820 further includes a communication module 824 and external device interface 826 that facilitates wired and/or wireless communication with other devices and components including, but not limited to a programmer 840 and external devices 842. Motor drive board 820 further controls various data acquisition functions using one or more data acquisition units 836. For example, data acquisition unit 836 may receive sensor data from motor sensors 852 associated with motor 850. Data acquisition unit 836 may also receive data from other components, such as sensors 862, which may be passed through to data acquisition unit 836, e.g., through drive/application board interface 810.

FIGS. 2-8 are intended to be illustrative only and may omit certain components for clarity. Moreover, although the particular components and systems included may vary between FIGS. 2-8, any components and systems discussed above may be included in implementations of the present disclosure. For example, any implementations discussed above exclude an emergency brake system, a data acquisition system, memory, or other systems and component discussed herein, may nevertheless be modified to include such systems unless otherwise specified.

Each of the various architectures discussed above may be suitable for different applications and for use in different exercise device designs. For example, the implementations of FIG. 3 may be suitable in cases where the power and drive electronics are to be deeply integrated with the mechanical equipment of the exercise device. In contrast, the simplified motor drives of FIGS. 4 and 5 may be beneficial in applications in which the motor drive and power electronics may are more loosely coupled to the system and/or can be added toward the end of an assembly process. The architecture of FIGS. 4 and 5 may also be useful in cases where the exercise device is suitable for configuration and operation at multiple power levels, each of which may require a different drive design. More generally, a given architecture may be implemented based on, among other things, a product roadmap or product line; upgradeability of the exercise device; manufacturing, sourcing, tariff, assembly, or other constraints; and the like.

### D. Communications and Digital Drive Electronics

In certain implementations, exercises devices in accordance with the present disclosure may include various components that simplify communication between internal and external components and systems. For example, exercise devices in accordance with the present disclosure may include a microcomputer, analog circuit, controller, etc. that simplifies communication by providing a direct interface. Such interfaces may conform to certain standards, including, but not limited to, RS485 or controller area network (CAN) standards. The interface may also support pulse width modulation (PWM) signaling or may be an analog interface that facilitates communication based on one or more voltage levels.

Signaling and communication in exercise devices according to the present disclosure may be facilitated by appropriate isolation/shielding. For example, in at least some implementations, signaling may be electrically isolated (e.g., through digital optical coupling or similar isolation techniques) to shield electronics of the exercise device from motor switching noise.

To the extent a digital interface is implemented between components, such interface may provide the added advantage of enabling advanced control configurations, and data reporting back to a controller of the exercise device. Such data may include, for example and without limitation, motor performance parameters (such as velocity, position, current, and the like), battery voltage, etc.

In certain implementations gate drive signals are provided directly from the application board to the switching circuit of the motor drive board. For example, FIGS. 4 and 5 each illustrate an example architecture in which the controller of the application controller board is communicatively coupled and directly provides gate drive signals or other control signals to the switching circuit of the motor drive without an intermediate controller. Such arrangements may have the advantage of making the motor drive less expensive and simpler to manufacture.

### E. Feedback

Control of exercise devices in accordance with the present disclosure and, more specifically, motors (e.g., brushless or AC motors) of such exercise devices may generally require rotor position feedback to maintain efficient operation and low speed torque. Accordingly, and with reference to FIG. 1, in at least some implementations, motor drive 106 may be configured to receive sensor measurements from motor assembly 108 or may include sensors for measuring various operational parameters of motor assembly 108. In the case of rotor position, the sensors may directly report rotor position or may provide data that may be processed, e.g., by motor drive 106, to determine rotor position. The rotor position determined by motor drive 106 may then be used by motor drive 106 to control motor assembly 108 and/or motor drive 106 may report (e.g., by a digital signal) rotor position to application controller 104 to facilitate further control and operation of exercise device 100. In addition to or instead of rotor position, motor drive 106 may act as an intermediary between application controller 104 and motor assembly 108 for any other measurable parameter of motor assembly 108.

Instead of or in addition to measuring rotor position of motor assembly 108, exercise device 100 may include various position-related sensors such as but not limited to pedal position sensors, rowing spool sensors, and the like. Such sensors may be used to eliminate the need for direct rotor position feedback. Specific sensor types used for this purpose may include, but are not limited to, encoders, hall effect sensors, magnetometers, magnetic reed sensors, inductive detectors, and resolvers.

Consolidation of sensors, such as by relying only on rotor position or another position-related sensor, may reduce the overall cost of exercise device 100 by eliminating redundant sensors and may, in certain cases, simplify control and operation of exercise device 100. Alternatively, exercise device 100 may include multiple sensors for providing position or other feedback. Such redundancy may increase reliability of exercise device 100.

### F. Tuning Interface

In at least certain implementations, motor drive 106 may include a tuning interface that facilitates programming and adjustment of motor drive 106. Such programming and adjustments may be used, for example, to adapt motor drive 106 for different applications/exercises, to tune performance characteristics of motor drive 106 for a particular application/exercise, to perform debugging/diagnostics of motor drive 106, and the like. Among other things and without limitation, the tuning interface may facilitate tuning/programming of motor drive 106 to account for different motors, to account for available sensors, to establish or modify safety thresholds, to access or modify operational parameters of motor drive 106, to change parameters associated with different operation modes (e.g., a power mode, torque delivery mode), to modify parameters related to thermal protection/active cooling, to enable particular operation modes (e.g., debug/R&D modes) and access corresponding data, and the like. In at least certain implementations, the tuning interface may be used to lock/unlock features, ranges, modes, etc., according to a subscription level or fee paid by the user.

The tuning interface may include a physical port on motor drive 106 and/or may include a software interface accessible, e.g., through a suitable wireless connection. In still other implementations, the tuning interface may be accessible from a remote computing device, e.g., over a network connection, to facilitate remote tuning, reprogramming, updating, diagnostics, etc. of motor drive 106.

In certain implementations, the tuning interface may be configured to facilitate initial programming, calibration, adjustment, etc. prior to shipping to a user or to otherwise be accessible only by a manufacturer of exercise device 100. In other implementations, at least some tuning features may be made available to a user.

As previously discussed in the context of FIGS. 2-8, in at least certain implementations of the present disclosure, the exercise device may include an external device interface (e.g., external device interface 326 of FIG. 3) or a communication module (e.g., communication module 324 of FIG. 3) that may communicate with one or more external devices. Such external devices may include a specialized programmer (e.g., programmer 342 of FIG. 3), which may be used to modify settings/configurations of the exercise device. Accordingly, in such cases, either of the communication module or the external device interface may operate as the tuning interface discussed above.

### G. Firmware Update

In certain implementations, motor control boards of the present disclosure may include a bootloader or similar base-level firmware interface. Such an interface may allow updates to firmware of a motor controller of the motor control board and may be accessed by a physical port of motor controller and/or via a wireless interface. In certain implementations, the firmware interface may be accessible by a remote computing device, e.g., over a network/the Internet, to facilitate deployment of firmware updates. As a result, firmware updates may be issued easily and at any time, including following deployment of an exercise device. In implementations in which communication is handled by an application controller, firmware updates for the motor controller or any other components of the exercise device may be received by the application controller and sent to the corresponding component, e.g., via a corresponding interface between the application controller and the component or received directly via onboard wireless or wired interfaces.

### H. Memory

As discussed, e.g., in the context of FIG. 3, motor control boards in accordance with the present disclosure may include a memory unit. Such a memory unit may be internal to a controller of the motor control board or may be a discrete unit separate from the control board. The memory may generally be used to store usage statistics, system fault history, a data log, operation cycle data, sensor information, other raw or computed metrics, and the like. Such data may be cyclically erased and re-written, remain on the device, and/or be transmitted externally for remote storage and/or processing by a wired and/or wireless connection. In implementations in which communications are handled by an application controller, recorded data may be transmitted or received from the motor control board by the application controller for external transmission. The recorded data may be used for various purposes including, but not limited to, analyzing usage information for devices under test or in the field or providing a “post-mortem” sequencing of events for failed units. The recorded data may also be used to provide statistical information to the user and for other user experience/user interface-related purposes. For example, in at least one implementation, collected usage data may be used to provide alerts, reminders, or similar notifications regarding how frequently or infrequently a user has completed a workout using the exercise device, which may include a comparison to the user's peers or other users of exercise devices in accordance with the present disclosure.

### I. Power Supply Multiplexing

Exercise machines often must dissipate energy produced during exertion by the user and draw energy to power themselves. Conventionally, exercise machines dissipate energy via large heat dissipation surfaces while simultaneously drawing power from an AC power source, such as a wall outlet. Such an approach can be very inefficient because the energy produced by the user is substantially wasted and AC power is potentially overconsumed.

To address the foregoing issue, among others, exercise devices in accordance with the present disclose may be configured to dynamically route power from a range of different sources to various loads of the exercise device, thereby facilitating efficient energy usage by the exercise device. More specifically, exercise devices according to the present disclosure may include a power multiplexer that facilitates power routing based on various factors. Among other things, the power multiplexer and associated power management system coordinates power flowing to/from various power-related components including, but not limited to, a battery, AC adapter, generative grid supply system, dissipation element, capacitor, or similar endpoint. In certain application, power multiplexer may be configured to route power based on various system inputs and/or may be configured to load balance between available power endpoints.

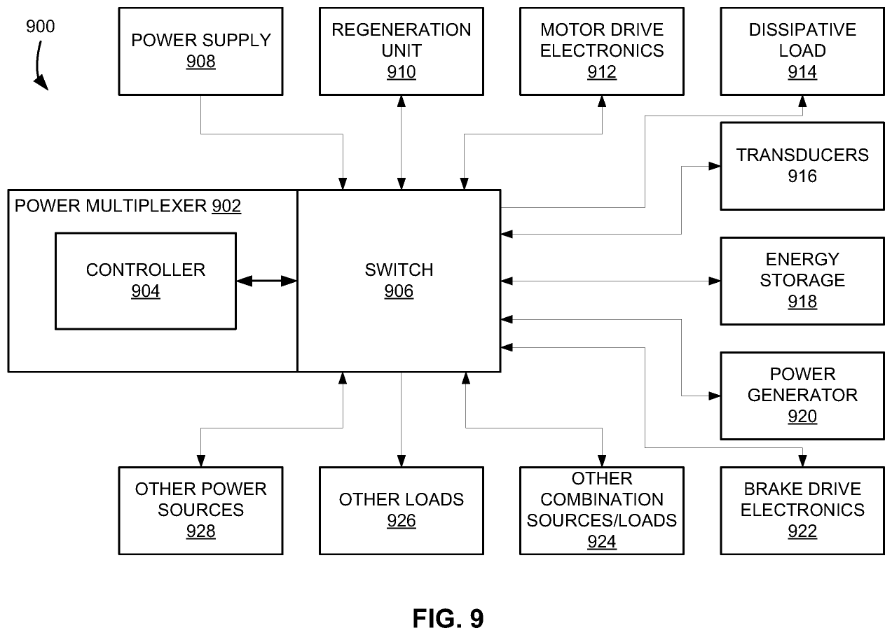

FIG. 9 is block diagram of an example power system 900 for use in an exercise device, such as exercise device 100 of FIG. 1. Power system 900 includes a power multiplexer 902 which acts as a hub for other power-related device components. As shown in FIG. 9, such components may include, but are not limited to, a power supply 908, a regeneration unit 910, motor drive electronics 912, a dissipative load 914, one or more transducers 916, an energy storage 918, a power generator 920, and brake drive electronics 922. Power multiplexer 902 is also shown as being connected to miscellaneous other combination power source/loads 924, loads 926, and sources 928, which are intended to include any suitable power source/sink currently known or later developed.

By way of example only and without limitation, sources/loads 908-928 may take various forms. Power supply 908, for example, may correspond to an AC adapter or similar plug that may be used with a conventional wall outlet. Regeneration unit 910 generally refers to any system of the exercise device from which power may be generated in response to use of the exercise device. For example, and without limitation, regeneration unit 910 may correspond to a regenerative braking system that captures energy from the motor windings as a user performs an exercise. Motor drive electronics 912 generally refers to electronics that direct and control power to the drive components (e.g., stator and rotor) of the motor of the exercise device. Such components may be incorporated into a motor controller, such as motor drive 106 of FIG. 1. Dissipative load 914 generally refers to any load used as a means for dissipating or “sinking” power. For example, in certain implementations, dissipative load 914 may be a ground resistor. Transducers 916 generally refer to any component that can convert between electrical and mechanical energy (either unidirectionally or bidirectionally). Among other things, transducers 916 may include triboelectric devices, piezoelectric devices, and electromechanical devices. Energy storage 918 generally refers to any component of the exercise device used to storage energy in any suitable form. In certain implementations, energy storage 918 may be a battery (e.g., a lithium-ion battery); however, energy storage 918 may also include other suitable energy storage components such as, but not limited to, a capacitor, a flywheel, a compressed gas, and the like. Power generator 920 generally refers to devices or systems capable of generating power and, in certain implementations, may correspond to a device that may be contained within the exercise device or that may be coupled to the exercise device. Examples of power generators include, without limitation, solar cells, fuel cells, wind turbines, and the like. Finally, brake drive electronics 922 generally refer to electronic components to facilitate braking of the exercise device. In implementations including plug or injection braking, brake drive electronics 922 may correspond to systems for applying DC voltage to the motor of the exercise device. Alternatively, brake drive electronics 922 may correspond to a system for apply mechanical braking force (e.g., by actuating a brake pad or similar braking element) to the motor.

As shown in FIG. 9, power multiplexer 902 generally includes a controller 904 that is communicatively coupled to and that controls a switch 906. Switch 906 is coupled to each of sources/loads 908-928 and, generally facilitates selective connection therebetween. Controller 904 may correspond to a standalone controller communicatively coupled to one or both of an application controller or motor controller (e.g., application controller 104 or motor drive 106). Alternatively, controller 904 may instead correspond to one or both of an application controller or motor controller of the exercise device. Stated differently, one or both of the application controller or the motor controller of the exercise device (alone or in combination) may be configured to provide some or all of the functionality of controller 904.

During operation, controller 904 generally determines how to route power between the sources/loads 908-928 and changes the state of switch 906 accordingly. Controller 904 can determine how to operate switch based on various factors.

In one example implementation, controller 904 may operate switch 906 based on the state of one or more of the sources/loads 908-928. Among other things, controller 904 may route power based on the presence or absence of certain sources/loads or operational conditions of available sources/loads.

In one specific example application, controller 904 may route power based on a charge state of a battery or similar energy storage 918. In such implementations, controller 904 may have access to or otherwise be provided with a charge state (e.g., a percent of capacity charged) of energy storage 918. While the charge state indicates charge below a certain threshold, controller 904 may route excess power (e.g., power not required for other exercise device functions) provided by one or more sources connected to switch 906 to energy storage 918. After a charge threshold of energy storage 918 is met or energy storage 918 is fully charged, controller 904 may operate switch 906 to route any excess power to dissipative load 914 or to some other energy storage device coupled to power multiplexer 902.

Controller 904 may also monitor or otherwise be provided with data corresponding to the operational state of one or more of sources/loads 908-928. In one example, controller 904 may be provided with operating temperatures of one or more of sources/loads 908-928 coupled to power multiplexer 902. If controller 904 determines that an operating temperature approaches or exceeds a safe operating temperature, controller 904 may begin routing power accordingly. Similarly, controller 904 may monitor current draw of loads coupled to power multiplexer 902 and may divert power in instances where overcurrent has occurred or is likely. Relatedly, controller 904 may operate switch 902 to route power in the event a component of the exercise device begins operating unpredictably, is damaged, fails, or otherwise behaves contrary to normal operation.

In other implementations, controller 904 may be configured to route based on characteristics of the power provided by sources and/or demanded by loads. For example, controller 904 may be provided with or have access to information regarding the power supplied by each source and demanded by each load (e.g., voltage, AC/DC, frequency, etc.). Controller 904 may then only route power between sources and loads having certain common characteristics. So, for example, controller 904 may only route power between sources and loads that operate within certain voltage ranges (e.g., low voltage, high voltage) or that have a certain current type (e.g., AC voltage or DC voltage). In any case, characteristics of power received from sources connected to power multiplexer 902 may differ from power required by loads connected to power multiplexer 902. In such cases, supplies/loads 908-922 may be coupled to transformers, rectifiers, inverters, converters, or other similar components for modifying power characteristics as required.

In still other implementations, controller 904 may be configured to route power based on anticipated or historic power consumption. In general, exercise devices in accordance with the present disclosure maintain a base level of power consumption when on but not in use. When a user performs an exercise, the power consumed by the exercise device and, in particular, the motor of the exercise device, increases in order to actuate the motor at the required speed and to provide the necessary resistance/loading. Accordingly, the power consumed by the motor may vary based on, among other things, the type of exercise being performed, the resistance to be provided during the exercise (including any changes in in resistance over the course of the exercise) speed at which the exercise is to be performed, and the like. So, for example, a relatively slow, low resistance exercise would generally involve a corresponding low but prolonged power consumption in order to provide the necessary actuation and resistance. Conversely, a fast, explosive movement with relatively high resistance would involve a corresponding high but short power consumption. Resistance and speed of an exercise may vary over the course of an individual rep, a set, or a workout. For example, and without limitation, a rep may involve application of a dynamic load over the range of motion of the rep, a set may involve gradually increase or decrease load between reps, or loading and speed may vary from set-to-set within a broader workout, which may include one or more distinct exercises.

In light of the foregoing, controller 904 may be configured to route power based on anticipated power consumption. For example, controller 904 may receive parameters for an exercise (e.g., exercise type, resistance level, etc.) or a workout consisting of multiple exercises. Responsive to receiving the parameters, controller 904 may calculate, among other things and without limitation, the amount, timing, and manner in which power is anticipated to be consumed, e.g., by the motor of the exercise device. During the workout progresses, controller 904 may control switch 906 to route power accordingly, e.g., by dynamically changing power routing through the power multiplexer 902 to provide the required resistance.

For example, and with reference to FIG. 9, during an initial warm-up phase of a workout, a user may perform exercises that are relatively slow and with low resistance such that all power needs of the motor may be met by power supply 908. Accordingly, controller 904 may configure power multiplexer 902 to route power from power supply 908 to motor drive electronics 912. To the extent power supply 908 is capable of providing additional power beyond what is required for the warm-up exercise, controller 904 may further configure power multiplexer 902 to route a portion of the power from power supply 908 to energy storage 918 and/or dissipative load 914. During a subsequent part of the workout, a higher resistance level may be required and controller 904 may dynamically increase the amount of power provided to motor drive electronics 912 and reduce the power provided to energy storage 918.

As another example, a user may start a workout with a first exercise that involves a relatively slow and consistent movement pattern and then change to a second exercise involving a substantially more explosive movement. In such cases, controller 904 may route power from power supply 908 to motor drive electronics 912 during the first exercise. Toward the end of the first exercise, controller 904 may begin routing power to a capacitor bank or similar energy storage element for providing the short bursts of increased resistance required during the second exercise and may continue routing power to the energy storage element while the second exercise is being performed.

Although illustrated in FIG. 9 as including one switch 906, power multiplexer 902 may include multiple switches, each of which may be used for routing power having certain characteristics. For example, power multiplexer 902 may include different switches for routing different voltages (e.g., each of a 120V, 12V, and 5V switch), with each switch being communicatively coupled to and operable by controller 904. Stated differently, controller 904 may be configured to simultaneously operate multiple switching hubs, with each hub corresponding to a certain set of power characteristics. Multiple hubs for a given set of power characteristics may also be implemented, e.g., in implementations in which physical grouping of separation of components may be desirable.

### J. Electric Braking

Exercise devices in accordance with the present disclosure may also include electric braking functionality. Electric braking may be performed in various ways; however, in general, electric braking involves modifying the current supplied to the motor stator windings such that rotation of the rotor in a first direction is opposed, e.g., by generating a torque in a second direction opposite the first direction. Electric braking may be used to slow or stop rotation of the motor, to dissipate power (particularly when other power dissipation or energy recapture elements are not present or unavailable for use), or, in some cases, to convert the kinetic energy of the rotor to electrical energy that may then be stored or used for other purposes.

In certain implementations of the present including an AC motor, the electric braking may be DC injection braking. DC injection generally includes first disconnecting AC voltage from the stator windings of the motor and subsequently applying a DC voltage to the stator windings. Doing so creates a stationary magnetic field and applies a torque to the rotor in the direction opposite to the rotor's current rotation, thereby slowing and eventually stopping rotation of the rotor. Once stopped, maintaining the DC voltage on the stator windings holds the rotor in place and provides substantial resistance to rotation of the rotor. The braking and holding forces are generally proportional to the DC voltage applied, with higher DC voltages resulting in greater braking and holding forces.

In at least certain implementations in which a multi-phase motor is used, electrical braking of the motor may be achieved by selectively shorting phases of the motor. For example, in implementations in which the motor is a three-phase motor, the switching circuit for driving the motor may be an inverter including a set of high side switches and a corresponding set of low side switches, with each high/low pair corresponding to a phase of the motor. During normal operation, the switch pairs are selectively opened and closed to provide power to each phase in an alternating manner. To short the phases, the high side switches may all be closed while maintaining the low side switches in an open position. Alternatively, shorting may be achieved by closing the low side switches while maintaining the high side switches in an open position. In either case, shorting of the phases results in braking of the rotor. In at least certain implementations, motor drives in accordance with the present disclosure may default into a shorted state in which braking is applied to the rotor, thereby resisting or preventing extension of the cable/handle of the exercise device.

In other implementations, electric braking may be achieved by plug braking. In general, plug braking refers to the process of reversing the field of the stator. In DC motors, plug braking is generally performed by reversing the polarity of the stator field. In AC motors, on the other hand, the stator field is rotating during operation of the motor. As a result, reversing the stator field involves reversing the direction of rotation of the stator field. In either case, reversing the field effectively creates a torque on the rotor that rapidly decelerates the rotor. In contrast to DC injection braking, in which the rotor may ultimately stop rotating, if the reverse field is maintained during plug braking, the rotor will ultimately begin rotating and accelerating in the reverse direction.

Electric braking may also be achieved by regenerative braking. During regenerative braking, current is cut off from the stator coils and the motor rotor is allowed to spin down. As the rotor spins within the stator, current is induced in the stator windings, effectively converting the motor into a generator. Current continues to be generated until the rotor stops rotating. Notably, interaction between the fields of the stator and rotor generally induces a torque on the rotor that slows the rotor as compared to simply allowing the rotor to freely spin within the stator. As a result, while regenerative braking is generally slower than active braking methods (e.g., DC injection or plug braking) at stopping the rotor, it generally slows the rotor faster than allowing the rotor to simply spin down freely while providing the added benefit of generating current that may be used or stored, e.g., in a battery or capacitor.

In certain implementations, electric braking may be applied by maintaining the electric braking current at a constant level. In others, electric braking may be performed periodically, e.g., according to a duty cycle. Such braking may be implemented, for example, to manage the braking level (e.g., gradual slowing versus sudden stop), to manage the amount of current generated as a result of braking, or to otherwise ease into application of the brake.

Although electrical braking is primarily described herein as being applied in response to a safety- or fault-related condition, electrical braking may also be applied during normal operation of an exercise device to smooth travel of a cable or other link, to provide feedback to a user, to provide resistance during an exercise, and the like. For example, at least certain exercises may include extension of a cable from a housing of the exercise device followed by retraction of the cable into the housing into a home or start position. In general, retraction may occur quickly. Accordingly, braking may be used as the cable/handle approaches the home/start position to avoid the cable/handle slamming into the housing or otherwise creating a potentially dangerous situation.

In certain implementations, electric braking may be controlled by the switching circuit of the motor drive. For example, in response to a particular switching control signal, the switching circuit may configure or control switches of the switching circuit to facilitate DC injection, plug, regenerative, or other braking techniques. In other implementations, electric braking may be facilitated, at least in part, by one or more second circuits, generally referred to herein as braking circuits, which may include switches or other components for selectively controlling power to or receiving power from the motor to initiate braking. Similar to the switching circuit, the braking circuits may include one or more switches for controlling power to windings of a motor stator to provide different braking modalities, the switches being operable to open/close (e.g., deenergize/energize the stator windings) in response to control signals received by the braking circuit.

### K. User and Device Safety

In certain implementations, exercise devices according to the present disclosure may include supervisory/firmware software, digital components, and/or analog components that control braking of the exercise device and, in response to certain events, transition of the exercise device into a “safe” or disabled mode. To that end, in at least certain implementations, the exercise device may include supervisory software/firmware (running in the same or different core from any software/firmware associated with normal operation), digital components, and/or analog components configured to force the motor to apply a brake (e.g., a plug brake, DC injection brake) in the event of the exercise device failing or operating in a potentially damaging way or upon the system detecting a user-related event, such as but not limited to the user falling, becoming injured, failing a movement, or otherwise being placed into a state of compromised physical ability for which completing motion would not be advisable. In certain implementations, the brake may also be applied in response to user input, such as a voice command or button press. In at least some implementations, braking of the exercise device may be achieved using plug braking due to plug braking resulting in the motor rotor becoming electrically “locked” and resisting rotation in either direction, even if a user-applied load is removed.

In certain cases, braking may include completely halting operation of the exercise device. However, in other cases, braking may instead result in a proportional increase or decrease relative to the intended force and/or displacement profile of a particular activity, or other measured or internal system parameters. For example, braking may be used to simulate a spotter when executing heavy lifts such that, in the event the user is unable to successfully and/or safely complete an exercise, the resistance applied to movement by the user may be reduced, thereby enabling the user to complete the exercise under a reduced load.

In at least certain cases, braking of the exercise device may result in protecting the exercise device and motor from damage. For example, braking may be instituted in response to a potential overspeed condition. Device safety modes may also be triggered by events sensed by thermal, humidity, force, or any of the other sensors of the exercise device in order to protect systems and components of the exercise device.

In at least certain implementations, braking may be applied in response to a user event that is detectable by a controller (e.g., an application controller or motor controller) of the exercise device. In a first example, the user event may be deviation from a force profile threshold. For example, a force profile may include a target force/load that a user is unable to achieve. In response, the exercise device may apply full or partial braking, thereby fully removing or reducing the load. Similarly, the user event may be a force that substantially exceeds a safety operating force of the motor (e.g., a force that may result in an overspeed or overtorque condition). As another example, the user event may be detection of a loss of signal from a sensor or disengagement of the user. For example, the exercise device may include dead man's switch integrated into a handle that the user grips during exercise or a platform on which the user stands during exercise. During normal operation, the switch is depressed and a corresponding signal is transmitted to a controller of the exercise device. If, however, the user releases the grip or steps off of the platform, the switch releases and halts the signal, causing the controller to activate the braking mechanism. As yet another example, braking may be applied in response to detecting a force reading indicative of a user imbalance. For example, in certain implementations, the exercise device may include a platform on which the user stands during exercise and which includes load cells, strain gauges, or other sensors that may be used to detect balance or foot position of the user. A brake may then be applied in the event an imbalance is detected (e.g., by measuring a high difference in force being applied by the user's feet). Finally, and more generally, braking may be applied in response to a signal generated from an algorithm identifying possible user safety issues by monitoring at least one of system, environmental, or state information.

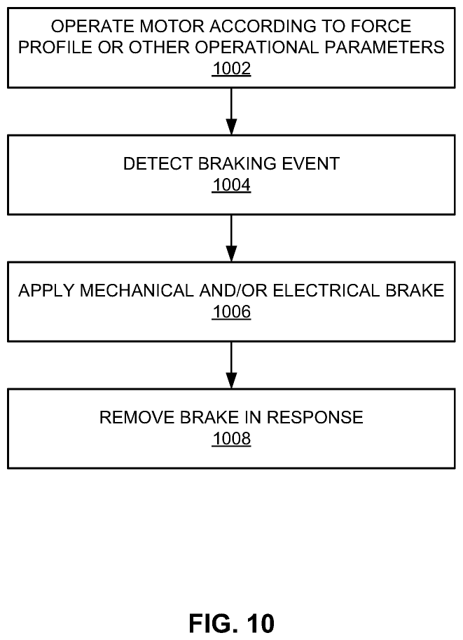

FIG. 10 is a flow chart illustrating an example method 1000 of braking in an exercise device. At operation 1002, the exercise device enters a normal operation state in which a controller of the exercise device controls output of a motor of the exercise device according to a force profile or similar operational parameters associated with a particular exercise. At operation 1004, a braking event is detected. As discussed above, the braking event may include a user-related event (e.g., the user failing to complete an exercise, disengaging from the exercise device, etc.) associated within maintaining safety of the user or a device-related event (e.g., component failure, overspeed condition, overcurrent condition, etc.) associated with maintaining safety of the exercise device itself. At operation 1006 and responsive to detecting the braking event, the exercise device activates a brake, which may be a mechanical and/or electrical brake, thereby slowing or stopping the motor. In implementations in which an electrical brake is used, the electrical brake may be a DC injection brake, a plug brake, a regenerative brake, or other electrical brake mechanism. Also in such implementations, application of the electric brake may include receiving a switching control signal at a switching circuit of a motor drive, the switching control circuit causing the motor drive to stop driving the motor. Further in response to the switching control circuit, the switching circuit or a braking circuit may be activated to provide one or more forms of electric braking. For example, in DC injection, the switching control circuit or braking circuit may be configured (e.g., by configuring switches of the circuit) to provide DC power to the stator windings of the motor. At operation 1008, the exercise device may release the brake, e.g., in response to a sensor measurement moving into a safe/acceptable range, a command from the user, a return to a home/zero position, or similar condition generally corresponding to or indicating resolution of the braking event.

### L. Counterforce Regularity and Calibration

To ensure regularity of force delivery, control loops for drives of exercise devices according to the present disclosure may also be coupled with feedback from various sensors of the exercise device or accessories/peripheral devices that may be used with the exercise device. Such sensors may be used, for example, to facilitate calibration or as a source of data/signals for a general control scheme. To that end, exercise devices in accordance with the present disclosure may include software to enable automatic calibration, tuning, or taring during production/manufacturing or as a part of regular use of the product. Such capabilities mitigate the impact of any one particular sensor in the system drifting with age, environmental conditions, etc. The calibration loop may also use feedback from other environmental sensors (including but not limited to thermal, humidity, g-force, or ambient pressure) on the motor, electronics, or elsewhere in the device to compensate for variations in the final force delivered.

In one specific example calibration routine, the exercise device may perform a “tug” test during which the motor is briefly activated to retract a cable of the exercise device and ensure the cable is in a “home”/zero position about which other system components may be configured. In such implementations, motor sensors may be used to monitor current, position, speed, etc. of the motor to determine whether the handle moved in response to the attempted retraction. Load cells, strain gauges, accelerometers, and other sensors may also be used to determine whether the cable/handle moved or if the handle exerted a load on other components of the exercise device as a result of being in the home position.

Similarly, a tug test may also be used to calibrate various sensors. For example, applying a known torque to the cable/handle should result in specific readings from various sensors (e.g., load cells, strain gauges, current/voltage sensors, etc.) of the exercise device and components/accessories thereof. Accordingly, to the extent the tug at the known torque does not result in the expected sensor readings, the sensors may be adjusted/calibrated accordingly.

### M. Sound and Feeling

Sound and feel are inherently tied to a user's experience when working out with an exercise device. To that end, many devices include dedicated audio, haptic, or similar feedback systems. However, with respect to motorized exercise devices, at least some of the sound and feel of the device is attributable to vibrations associated with operation of the motor of the device, including how the motor is driven. In light of the foregoing, exercise devices in accordance with the present disclosure may include functionality directed to controlling a motor drive to enhance the audible and/or tactile experience of the user.

Operational noise of an electric motor generally results from vibration of the motor due to multiple factors including, but not limited to, switching frequency, commutation mode, and other underlying parameters (e.g., current/voltage amplitude supplied to the motor). For example, a trapezoidal commutation scheme may generally result in a pronounced vibration of the motor that produces an audible buzzing sound and corresponding tactile buzz which may be felt, for example, by touching or holding a component coupled to or in contact with the motor (e.g., a handle attached to the motor by a cable). If a low frequency sinusoidal commutation scheme with similar parameters is instead implemented, the buzzing sound and feel is generally replaced with a less sharp/pronounced hum. In certain instances, the hum may be attenuated by increasing the frequency of the sinusoidal commutation scheme until it becomes effectively imperceptible.

By leveraging the foregoing concepts, motor drives of exercise devices in accordance with the present disclosure may be controlled to provide different aural and/or tactile experiences during use. Such control may be in response to various events or parameters including, without limitation, a user profile, a time of day, an exercise type, a workout type, a workout or exercise intensity, a battery state, the availability and range of power sources, motor type/configuration, sensor type/configuration, temperature, or manual input.

Although various different operational modes may be possible, in a first example mode, the exercise device may be configured to emit a low hum, e.g., by driving the motor using a low frequency commutation scheme. Such a mode may be useful or preferred by certain users to communicate that the exercise device is on/active. In a second example mode, the exercise device may be configured to operate in a “silent” mode, e.g., by driving the motor using a high frequency sinusoidal commutation scheme. In a third mode, the exercise device may be configured to operate in a “noisy” mode in which more pronounced audial and tactile buzzing is produced. Such a mode may be preferred, for example, in louder environments (e.g., gym settings) to overcome ambient noise.

As yet another example, the drive of the motor may be controlled in response to exercise/workout progression or intensity. For example, at the outset of a set or workout, the motor may be initially operated to produce a low vibration. As the user performs more repetitions, increases resistance, or otherwise increases the intensity of the workout, the audial and tactile sensation provided may be increased by increasing the intensity of the hum or producing a more pronounced buzzing sound.

In certain implementations, the motor may be driven to produce different vibration profiles over the range of motion of a single exercise. For example, to create a “whooshing” sound and feel, similar to that of a rower/ergometer, the motor may be driven by a noisy/buzzy signal during a first portion of the exercise but gradually transition to a quieter or even silent sound toward the end of the range of motion. To do so, the motor may initially drive the motor with a low frequency sinusoid or trapezoidal commutation scheme but transition, e.g., by increasing switching frequency of a switching circuit of the drive, as the user progresses through the range of motion for the exercise. Stated differently, the motor drive may be controlled to produce vibrations having different characteristics based on, among other things, how a user performs an exercise, where a user is within an exercise, and the like.

Control of the motor drive to provide different sound/feel may be performed by any suitable controller of the exercise device that controls switching and other operation of the motor drive. So, for example, in implementations of the present disclosure including a modular motor drive with a separate controller, control of the motor drive to achieve different sound/feel during use may be performed by the motor drive controller. Similarly, in implementations in which motor drive control is provided by a controller of an application board or in which the motor drive is not a separate modular unit, control may instead be provided by the controller of the application board.

In implementations in which sound/feel control is implemented in a modular motor drive, different motor drives may be configured to provide different user experiences. For example, certain modular motor drives may be specifically tailored to producing high frequency drive signals for purposes of producing substantially silent operation. Other modular motor drives may instead be configured to produce multiple perceptible “volumes” or intensities. In still other cases, modular motor drives may be configured to produce sound/feel profiles associated with a particular exercise, as noted above in the case of rowers/ergometers.

### N. Other Considerations/Applications

Although focused primarily in the context of exercise devices with rotating actuators/motors, concepts included herein may be readily adapted to other force generation systems. For example, the modular motor drive concept discussed herein may be adapted to drive linear motors, hydraulics, pneumatics or other force delivery actuators. Other example applications of the concepts discussed herein include industrial robotics, industrial automation equipment, medical equipment, mobile robotics, electric vehicles, passenger vehicle cabin controls, electrical power generators, and the like.

### O. Computing System

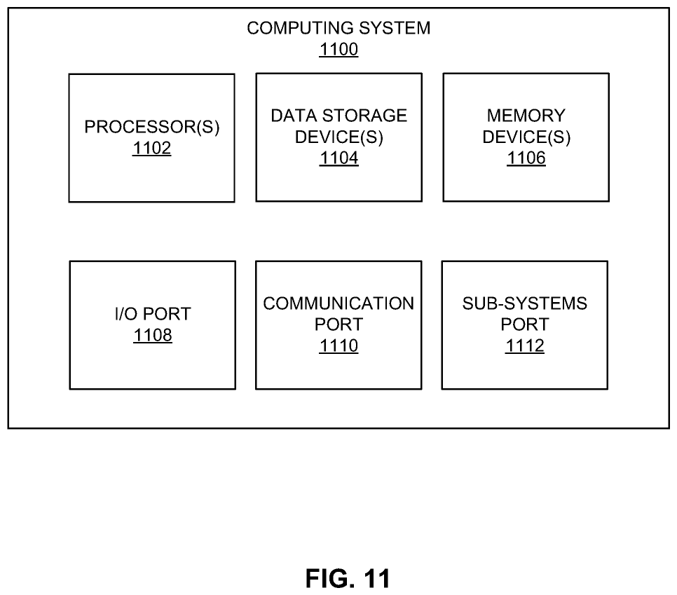

Referring to FIG. 11, a block diagram illustrating an example computing system 1100 having one or more computing units that may implement various systems, processes, and methods discussed herein is provided. For example, example computing system 1100 may correspond to, among other things, one or more of an application controller of an exercise device in accordance with the present disclosure, a motor controller of a motor drive, a user computing device in communication with an exercise device, or any similar computing device included in a system incorporating aspects of the present disclosure. It will be appreciated that specific implementations of these devices may be of differing possible specific computing architectures not all of which are specifically discussed herein but will be understood by those of ordinary skill in the art.

Computing system 1100 may be a computing system capable of executing a computer program product to execute a computer process. Data and program files may be input to computing system 1100, which reads the files and executes the programs therein. Some of the elements of computing system 1100 are shown in FIG. 11, including one or more hardware processors 1102, one or more data storage devices 1104, one or more memory devices 1108, and/or one or more ports 1108-1112. Additionally, other elements that will be recognized by those skilled in the art may be included in computing system 1100 but are not explicitly depicted in FIG. 11 or discussed further herein. Various elements of computing system 1100 may communicate with one another by way of one or more communication buses, point-to-point communication paths, or other communication means not explicitly depicted in FIG. 11.

Processor 1102 may include, for example, a central processing unit (CPU), a microprocessor, a microcontroller, a digital signal processor (DSP), and/or one or more internal levels of cache. There may be one or more processors 1102, such that processor 1102 comprises a single central-processing unit, or a plurality of processing units capable of executing instructions and performing operations in parallel with each other, commonly referred to as a parallel processing environment.

Computing system 1100 may be a conventional computer, a distributed computer, or any other type of computer, such as one or more external computers made available via a cloud computing architecture. The presently described technology is optionally implemented in software stored on data storage device(s) 1104, stored on memory device(s) 1106, and/or communicated via one or more of ports 1108-1112, thereby transforming computing system 1100 in FIG. 11 to a special purpose machine for implementing the operations described herein. Examples of the computing system 1100 include personal computers, terminals, workstations, mobile phones, tablets, laptops, personal computers, multimedia consoles, gaming consoles, set top boxes, and the like.

One or more data storage devices 1104 may include any non-volatile data storage device capable of storing data generated or employed within computing system 1100, such as computer executable instructions for performing a computer process, which may include instructions of both application programs and an operating system (OS) that manages the various components of computing system 1100. Data storage devices 1104 may include, without limitation, magnetic disk drives, optical disk drives, solid state drives (SSDs), flash drives, and the like. Data storage devices 1104 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. One or more memory devices 1106 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in data storage devices 1104 and/or memory devices 1106, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, computing system 1100 includes one or more ports, such as an input/output (I/O) port 1108, a communication port 1110, and a sub-systems port 1112, for communicating with other computing, network, or similar devices. It will be appreciated that ports 1108-1112 may be combined or separate and that more or fewer ports may be included in computing system 1100.

I/O port 1108 may be connected to an I/O device, or other device, by which information is input to or output from computing system 1100. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into computing system 1100 via I/O port 1108. Similarly, the output devices may convert electrical signals received from computing system 1100 via I/O port 1108 into signals that may be sensed as output by a human, such as sound, light, and/or touch. The input device may be an alphanumeric input device, including alphanumeric and other keys for communicating information and/or command selections to processor 1102 via I/O port 1108. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from computing system 1100 via I/O port 1108. For example, an electrical signal generated within computing system 1100 may be converted to another type of signal, and/or vice-versa. In one implementation, the environment transducer devices sense characteristics or aspects of an environment local to or remote from computing system 1100, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing system 1100, such as, physical movement of some object (e.g., a mechanical actuator), heating or cooling of a substance, adding a chemical substance, and/or the like.

In one implementation, a communication port 1110 is connected to a network by way of which computing system 1100 may receive network data useful in executing the methods and systems set out herein as well as transmitting information and network configuration changes determined thereby. Stated differently, communication port 1110 connects computing system 1100 to one or more communication interface devices configured to transmit and/or receive information between computing system 1100 and other devices by way of one or more wired or wireless communication networks or connections. Examples of such networks or connections include, without limitation, Universal Serial Bus (USB), Ethernet, WiFi, Bluetooth®, Near Field Communication (NFC), Long-Term Evolution (LTE), and so on. One or more such communication interface devices may be utilized via communication port 1110 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, communication port 1110 may communicate with an antenna for electromagnetic signal transmission and/or reception.

Computing system 1100 may include a sub-systems port 1112 for communicating with one or more sub-systems, to control an operation of the one or more sub-systems, and to exchange information between computing system 1100 and the one or more sub-systems. Examples of such sub-systems include, without limitation, imaging systems, radar, lidar, motor controllers and systems, battery controllers, fuel cell or other energy storage systems or controls, light systems, navigation systems, environment controls, entertainment systems, and the like.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Although various representative embodiments have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member, or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A modular motor drive for use in fitness equipment, the modular motor drive comprising:
a switching circuit comprising a plurality of switches, the switching circuit responsive to switching control signals by selectively reconfiguring the plurality of switches to control supply of electrical energy to a motor of an exercise device according to the switching control signals; and
an interface coupleable with an application control board of the exercise device,
wherein:
responsive to a first switching control signal, the switching circuit configures the plurality of switches to drive the motor of the exercise device, and
responsive to a second switching control signal corresponding to electric braking of the motor, the switching circuit configures the plurality of switches to stop driving the motor of the exercise device.

2. The modular motor drive of claim 1, wherein the motor is an alternating current (AC) motor and at least one of the switching circuit or a braking control circuit of the modular motor drive is configured to apply direct current (DC) to a stator winding of the motor responsive to the second switching control signal, thereby braking the motor by DC injection braking.

3. The modular motor drive of claim 1, wherein at least one of the switching circuit or a braking control circuit is configured to reverse a field of a stator winding of the motor responsive to the second switching control signal, thereby braking the motor by plug braking.

4. The modular motor drive of claim 3, wherein the motor is an AC motor and reversing the field of the stator winding includes reversing a rotation of the field of the stator winding.

5. The modular motor drive of claim 1, wherein at least one of the switching circuit or a braking circuit is configured to route power generated by the motor responsive to the second switching control signal, thereby braking the motor by regenerative braking.

6. The modular motor drive of claim 5 further comprising a second interface for operably interconnecting the at least one of the switching circuit and the braking circuit to a power system of the exercise device to provide power from the motor to the power system during regenerative braking.

7. The modular motor drive of claim 1 further comprising a motor drive controller communicatively coupled to the switching circuit, the interface further for communicatively coupling the motor drive controller to an application controller of the application control board.

8. The modular motor drive of claim 7, wherein the switching circuit is configured to receive switching control signals including the first switching control signal and the second switching control signal from the motor drive controller.

9. The modular motor drive of claim 1, wherein the interface is further for communicatively coupling the switching circuit to an application controller of the application control board.

10. The modular motor drive of claim 9, wherein the switching circuit is configured to receive the first switching control signal and the second switching control signal from the application controller.

11. The modular motor drive of claim 1, wherein the second switching control signal is generated responsive to a user event associated with a user of the exercise device.

12. The modular motor drive of claim 11, wherein a user event is detectable based on at least one of meeting a threshold deviation from a force profile, detecting a loss of signal from a sensor, detecting a force reading indicative of a user imbalance, detecting a sensor signal indicative of user disengagement, or receiving a signal from an algorithm identifying possible user safety issues by monitoring at least one of system, environmental, or state information.

13. The modular motor drive of claim 1, wherein at least one of the switching circuit and a braking circuit is configured to short phases of the motor responsive to receiving the second switching control signal.

14. The modular motor drive of claim 13, wherein the at least one of the switching circuit and the braking circuit is configured to default into a state in which the motor phases are shorted.

15. An exercise device comprising:
a motor assembly comprising a motor;
an application board comprising an application board controller; and
a motor drive operably coupled to each of the motor and the application board, the motor drive comprising a switching circuit comprising a plurality of switches, the switching circuit responsive to switching control signals by selectively reconfiguring the plurality of switches to control supply of electrical energy to the motor according to the switching control signals,
wherein
responsive to a first switching control signal, the switching circuit configures the plurality of switches to drive the motor, and
responsive to a second switching control signal corresponding to electric braking of the motor, the switching circuit configures the plurality of switches to stop driving the motor.

16. The exercise device of claim 15, wherein the switching circuit is configured to receive the first control signal and the second control signal from the application board controller.

17. The exercise device of claim 15, wherein the motor drive further comprises a motor drive controller operably coupled to the application board controller and the switching circuit is configured to receive the first control signal and the second control signal from the motor drive controller.

18. The exercise device of claim 15, wherein the electric brake is one of a DC injection brake, a plug brake, or a regenerative brake.

19. A method of controlling motors in fitness equipment, the method comprising:
at a switching circuit of a motor drive coupled to a motor of an exercise device, the switching circuit comprising a plurality of switches and responsive to switching control signals by selectively reconfiguring the plurality of switches to control supply of electrical energy to the motor according to the switching control signals, receiving a switching control signal; and
responsive to receiving the control signal during driving of the motor, activating the switching circuit to stop driving the motor; and
applying an electric brake to the motor by at least one of DC injection braking, plug braking, or regenerative braking,
wherein:
the exercise device includes each of an application board including an application controller and a modular motor drive operably connected to the application board, the modular motor drive including the switching circuit and a motor drive controller operably connected to the application controller, the switching control signal received by the switch circuit from the motor drive controller.

20. The method of claim 19, wherein the modular motor drive is a first modular motor drive and the switching circuit is a first switching circuit, the method further comprising:
subsequent to replacement of the first modular motor drive with a second modular motor drive and at a switching circuit of the second modular motor drive, receiving a second control signal; and
responsive to receiving the second control signal, activating the switching circuit to at least one of drive the motor or electrically brake the motor.
